(19) United States
(12) Patent Application Publication
(10) Pub. No.: US 2011/0131028 A1
(43) Pub. Date: Jun. 2, 2011

(54) CELL POPULATION SYSTEM AND PROCESS

(76) Inventors: Philip Desmond Hodgkin, Victoria (AU); Edwin David Hawkins, Victoria (AU); Marian Linnett Turner, Victoria (AU); Mark Raymond Dowling, Victoria (AU); Carel Van Gend, Cape Town (ZA); Cameron James Wellard, Victoria (AU); John Fraser Markham, Victoria (AU)

(21) Appl. No.: 12/312,933

(22) PCT Filed: Nov. 30, 2007
(86) PCT No.: PCT/AU2007/001842

§ 371 Date: Nov. 12, 2010

(30) Foreign Application Priority Data
Dec. 1, 2006 (AU) 2006906744

(51) Int. Cl. G06G 7/60

(52) U.S. Cl. 703/11

(57) ABSTRACT

A cell population process executed by a computer system, the process including generating cell population data representing numbers of cells in a cell population from one or more probability distributions representing probabilities for cell division in the absence of cell death in successive generations of cells of the cell population, and one or more probability distributions representing probabilities for cell death in the absence of cell division in successive generations of cells of the cell population.

### FIELD

The present invention relates to a cell population system and process, and in particular to a system and process for generating cell population data representing numbers of cells in a cell population.

### BACKGROUND

Many biological processes, including embryogenesis, organogenesis and hematopoiesis, are controlled by the growth and survival of cells of various types. In particular, the regulation of growth and survival is achieved to an exquisite level in the human immune response. The human immune defence system is stimulated by a complex cascade of chemical signals, making it difficult to predict in advance the immune response to any given stimulus. One method of measuring the adaptive human immune response is to count the number of white blood cells, i.e., T and B lymphocytes, present in the body. The count of lymphocytes will change over time, governed by each cell's activity. At any time, a cell can be considered to be in one of three states: (i) quiescence, where the cell does nothing, (ii) proliferation, where the cell divides, and (iii) apoptosis, where the cell dies. A complex interaction of receptor-mediated signals determines which of the three cell states a lymphocyte enters and when.

The time between cell division events, i.e., the intermitotic time, of yeast, protozoan and mammalian cells can vary broadly. The bulk of the variability in intermitotic times occurs in the G1, or ‘first gap’, phase of a cell cycle; the G1 phase of the cell division cycle is the period when the cell is neither dividing nor preparing for division.

Broad variations have also been observed in times to first division by otherwise similar murine and human lymphocytes. It is not clear whether this variability arises internally within identical cells, or as the result of a history of variable exposure of identical cells to external influences. Irrespective of its genesis, this variability in time to first division is the primary source of cell division heterogeneity in populations identified by fluorescent division tracking methods. This observation has been used to develop relatively simple models of cell growth and death, which can be used to extract division and death rates from time series data, as described in E. K. Deenick, A. V. Gett, P. D. Hodgkin, J Immunol 170, 4963 (2003), and A. V. Gett, P. D. Hodgkin, Nat Immunol 1, 239 (2000).

However, more accurate models of cell division and survival are desired to understand and predict the variation in times to death, the interleaving of times to divide and die within individual cells, and how these processes occur in subsequent division rounds, e.g., in child and grandchild cells. A minimal, six-parameter quantitative process for estimating lymphocyte growth and modeling cell division tracking data is described in E. K. Deenick, A. V. Gett, and P. D. Hodgkin, J Immunol 170, 4963, (2003) (“Deenick”); this model combines probabilistic variability in entry time to first division, with a fixed subsequent division time and a fixed proportion of cells lost (i.e., dying) per division. The manner of approximating subsequent division and survival described in Deenick is most accurate under conditions of strong stimulation, but can yield significant errors under weaker stimulation conditions, characterised by slower division times and greater variation within the population.

It is desired, therefore, to provide a cell population system and process that alleviate one or more difficulties of the prior art, or at least to provide a useful alternative.

### SUMMARY

In accordance with the present invention, there is provided a cell population process executed by a computer system, the process including
generating cell population data representing numbers of cells in a cell population from one or more probability distributions representing probabilities for cell division in the absence of cell death in successive generations of cells of said cell population, and one or more probability distributions representing probabilities for cell death in the absence of cell division in successive generations of cells of said cell population.

Advantageously, said probability distributions represent probability densities as a function of time.

Advantageously, at least one of said probability distributions changes with cell generation.

Preferably, said cell population data represents numbers of dividing cells in respective generations of cells, and numbers of dead cells in respective generations of cells.

Advantageously, each of said probability distributions may be a gamma distribution.

Advantageously, each of said probability distributions may be a Weibull distribution.

Advantageously, each of said probability distributions may be a beta distribution.

Preferably, each of said probability distributions is a lognormal probability distribution.

Preferably, said cell population data is generated on the basis of a first probability distribution representing probabilities for cell division in an initial cell population, and at least one second probability distribution representing probabilities for cell division in subsequent generations of cells in said cell population.

Preferably, said cell population data is generated on the basis of a first probability distribution representing probabilities for cell death in an initial cell population, and at least one second probability distribution representing probabilities for cell death in subsequent generations of cells in said cell population.

Advantageously, the process may include determining a number of cells in each generation that can divide, said number being a fixed proportion of the total number of cells in said generation.

Advantageously, the process may include determining a number of cells in each generation that can divide, said number being a variable proportion of the total number of cells in said generation.

Advantageously, the variable proportion varies with successive cell generations.

Preferably, the process includes determining the variable proportion on the basis of a truncated normal probability distribution.

Advantageously, the process may include fitting said cell population data to corresponding measured cell population data to determine parameters of at least one of said probability distributions.

Advantageously, the process may include fitting said cell population data to correspond measured cell population data to determine number of cells in each generation that can divide.

Advantageously, said cell population data also represents numbers of cells of different types in said cell population, the cell population data also being generated from one or more probability distributions representing probabilities for cell differentiation in the absence of cell division and cell death in successive generations of cells of said cell population.

In accordance with the present invention, there is provided a cell population process, including:
determining numbers of cells in a cell population that divide at respective time intervals from a distribution of times-to-divide of cells in said cell population and a distribution of times-to-die of cells in said cell population; and
determining numbers of cells in said cell population that die at respective time intervals from a distribution representing times-to-divide of cells in said cell population and a distribution of times-to-die of cells in said cell population.

Preferably, the process includes:
determining numbers of cells in respective generations of cells of a cell population that divide at time intervals from one or more distributions of times-to-divide of cells in generations of said cell population and a distribution of times-to-die of cells in said cell population; and
determining numbers of cells in said cell population that die at respective times intervals from a distribution representing times-to-divide of cells in said cell population and a distribution of times-to-die of cells in said cell population.

Preferably, the process includes:
determining said distribution of times-to-divide on the basis of measurements of a cell population substantially in the absence of cell death; and
determining said distribution of times-to-die of cells in said cell population substantially in the absence of cell division.

Advantageously, the process may include:
determining the effect of a second stimulus or genetic variation on at least one second parameter of at least one of said probability distributions; and
wherein said step of generating cell population data includes generating, on the basis of said determined effects on said at least one first parameter and said at least one second parameter, cell population data representing numbers of cells in said cell population subject to said first stimulus or genetic variation and said second stimulus or genetic variation to predict the combined effect of said first stimulus or genetic variation and said second stimulus or genetic variation.

Advantageously, said first stimulus includes a drug.

Advantageously, said first genetic variation includes a genetic mutation or polymorphism.

The present invention also provides a system having components for executing the steps of any one of the above processes.

The present invention also provides a computer-readable storage medium having stored thereon program instructions for executing the steps of any one of the above processes.

The present invention also provides a cell population system, including means for generating cell population data representing numbers of cells in a cell population from one or more probability distributions representing probabilities for cell division in the absence of cell death in successive generations of cells of said cell population, and one or more probability distributions representing probabilities for cell death in the absence of cell division in successive generations of cells of said cell population.

Preferably, wherein said cell population data also represents numbers of cells of different types in said cell population, the system being configured to generate said cell population data from one or more probability distributions representing probabilities for cell differentiation in the absence of cell division and cell death in successive generations of cells of said cell population.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of a system for generating cell population data;

FIG. 2 is a flow diagram of a cell population data generation process executed by the system;

FIGS. 3A to 3C are graphs of the number of live cells in a cell population as a function of time, including lognormal survival curves fitted to experimental data;

FIG. 3D is a graph of the means and variances of times to die of cells in a cell population, as a function of IL-4 concentration;

FIG. 4 includes a graph of the decreasing fraction of live cells in a cell population over time for B cells from bim deficient mice and bcl-2 over-expressing mice, and a graph of the corresponding lognormal distributions of times to die of those cells;

FIG. 5A is a graph of entry to first division as a function of time for B cells stimulated to divide and harvested using two different concentrations of stimulus;

FIG. 5B is a graph of the corresponding total number of live cells as a function of time;

FIG. 5C is a graph of the lognormal distribution of time-to-divide for the cells in the B cell population and the lognormal distribution of time-to-die (plotted negatively) for the same population;

FIG. 5D is the same graph as FIG. 5C, but includes a plot of the resulting fraction of cells that divide and die at each time interval, determined from the two distributions;

FIG. 6A is a schematic representation of the two ‘clocks’ internal to each cell that determine the time that the cell will divide (if it doesn't die first) or die (if it doesn't divide first), and showing two alternative possible fates for the call;

FIG. 6B is a schematic representation of a population of cells and the distributed values of the times-to-divide and the times-to-die in that population;

FIG. 6C is a schematic representation of the two skew probability distributions representing the times-to-divide and the times-to-die in the population of FIG. 6B;

FIG. 7A includes a graph of the number of live cells in a cell population over time, generated from paired distributions of times-to-divide and times-to-die in that population, illustrating the dramatic changes that can result from small changes in the relative means of the two distributions in each pair;

FIG. 7B includes a graph of the total number of live cells in a population over time (upper graph), and a graph of the number of live cells in each division of the population over time (lower graph), and including curves generated by the system;

FIG. 7C includes graphs of the paired distributions of times-to-divide and times-to-die generated by the system for the population of FIG. 7B, for the zeroth division (upper graph) and all subsequent divisions (lower graph);

FIG. 8A is a graph of the number of live cells in each division of a B cell population as a function of time, stimulated over various periods prior to division, as indicated;

FIG. 8B is a graph of the mean division number as a function of time, shown for the various stimulation periods of FIG. 8A;

FIG. 8C is a graph of the progressor fraction as a function of division, shown for the various stimulation periods of FIG. 8A;

FIG. 8D is a graph of the paired distributions of times-to-divide and times-to-die generated by the system to fit the experimental data of FIGS. 8A to 8C;

FIGS. 8E to 8H are graphs of the total number of live cells (i.e., in all division classes) as a function time for a control population, and populations stimulated for 30, 40, and 50 hours, respectively, including system generated fits to the experimental data;

FIGS. 9A to 9D are graphs of data fitted by the cell population system, showing total cell numbers in each division class at four harvest times for B cells stimulated constantly (FIG. 9A), or stimulated for 30 hours (FIG. 9B), 40 hours (FIG. 9C), or 50 hours (FIG. 9D);

FIGS. 10A to 10G represents the same experimental data shown in FIGS. 7B and 7C but with the cell population data regenerated to allow the progressor fraction to change with division class, as shown in FIG. 10D;

FIG. 11 is a set of four bar charts showing increased antibody production from F1 progeny of NZB and NZW mice. B cells from NZB, NZW and 4 F1 progeny were stimulated with LPS and cytokines for 4 days. The total number of ASC produced, assessed by syndecan expression, and the total amount of IgM secreted, were determined. F1 mice make twice as much antibody as either parent;

FIG. 12 is a set of four CFSE profiles from NZB, NZW and F1 B cells. Note the intermediate proliferation effect of the F1 cells;

FIGS. 13A to 13F are graphs showing cell population data generated by fitting cell population (model) parameters to CFSE time series data for NZB (top panel, FIG. 13A) NZW (mid panel, FIG. 13B) and (NZB×NZW F1) (bottom panel, FIG. 13C), with FIGS. 13D to 13F showing the corresponding total cell population size as a function of time. Data points shown are the mean of triplicate cultures; the dashed lines are fits generated by the system.

FIG. 14 is a set of graphs of the optimal interleaving probability distributions generated by the system for responses of autoimmune B cells. (First division: φ₀med=39.50, s=0.238, ψ₀ med=59.3, s=0.743. Subsequent division: φ_{i>0} med=7.9, s=0.15, ψ_{i>0} med=40.60, s=0.34. Progressor fraction: pF₁=0.874, μ=3.40, σ=1.59, pF₀−NZB=0.529, NZW=0.277, (NZB×NZW)F1=0.355).

FIG. 15 is a graph of the cumulative proportion of cells developing into ASC per division for NZW, NZB, and F1 cells;

FIG. 16 is a bar chart showing the predicted numbers of ASCs after 4 days. The F1 is predicted to produce about twice as much antibody as either parent, as experimentally observed in FIG. 11;

FIG. 17, Isolating inhibitory effects to independent parameters of the B cell response. 4.5×10⁴ cells were stimulated with 20 ug/ml LPS and effects of a series of compound monitored. The top panel (FIGS. 17A to 17D) illustrates the specific action of compound WEHI-71093 on antibody secreting cells. FIG. 17A shows that the live cell content is not affected relative to the DMSO control. FIG. 17B uses a blimp-1-GFP reporter strain to demonstrate that the number of ASC generated is also not affected. FIG. 17C shows that the level of isotype switching to IgG3 is also unaffected by the compound. However, FIG. 17D reveals that, despite the same number of B cells and ASC, the IgM and IgG3 output is reduced. The lower panel (FIGS. 17E to 17G) shows the specific effect of a second compound (WEHI-10601). FIG. 17E shows overlays of CFSE proliferation, showing no difference from the control. FIG. 17F is a bar chart showing the compound's inhibition of ASC, as revealed using syndecan. FIG. 17G is a bar chart showing that the level of isotype switching to IgG3 is not affected by the compound;

FIG. 18 is a schematic representation of an example of lymphocyte differentiation, in which a B lymphocyte begins as an IgM+ cell that can switch to IgG with a probability ηᵢ(t), in division i. Both IgM and IgG B cells can become antibody secreting cells (ASC) with respective probabilities ξᵢ(t) and ζᵢ(t) in division i;

FIG. 19 includes four graphs comparing the predicted evolution of numbers of IgM+ASC−, IgM+ASC+, IgG+ASC−, and IgG+ASC+ cells over time with experimental measurements; and

FIG. 20 is a graph comparing the total accumulated amounts of secreted IgM and IgG as a function of time with experimental measurements.

### DETAILED DESCRIPTION OF THE PREFERRED EMBODIMENTS

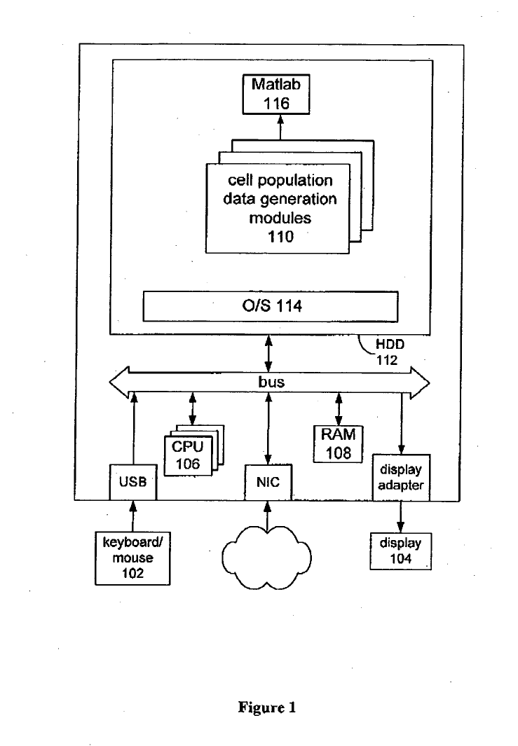

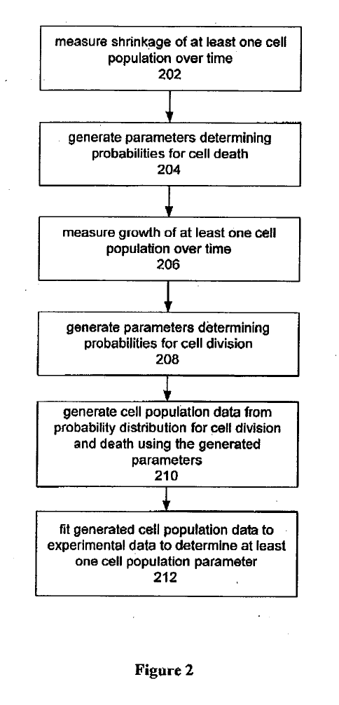

As shown in FIG. 1, a system for generating cell population data (also referred to herein as the cell population system) includes an input device such as a keyboard 102, a display device 104, at least one processor 106, random access memory 108, and cell population data generation modules 110. The system executes a cell population data generation process, as shown in FIG. 2, also referred to herein as the cell population process, that generates cell population data representing the numbers and types of cells in a cell population at one or more future times by taking into account the competing processes of cell division, cell death, and cell differentiation, and the effects of any external stimuli and/or genetic variations on these competing processes.

In the described embodiment, the system is a standard computer system such as an Intel Architecture based computer system, and the cell population data generation process is implemented by software modules, being the cell population data generation modules 110 stored on non-volatile (e.g., magnetic disk) storage 112 associated with the computer system and executed by the processor 106. Also stored on the non-volatile storage 112 is an operating system 114 such as Microsoft Windows™, and the Matlab software application 116, available from http://www.mathworks.com/products/matlab, the cell population modules 110 being based on matrix functions provided by Matlab. However, it will be apparent that the cell data generation process can alternatively be implemented by dedicated software modules written in a programming language such as Fortran, and omitting the Matlab component 116. Additionally, it will be apparent to those skilled in the art that the components of the system can be distributed over a variety of locations, and that at least parts of the processes executed by the system can alternatively be implemented by dedicated hardware components, such as application-specific integrated circuits (ASICs) and/or Field Programmable Gate Arrays (FPGAs).

As described above, the cell population data generation process generates cell population data representing changes in a cell population over time, and in particular the number of cells in that cell population. The cell population data is generated on the basis that the biological processes determining cell division are independent of those determining cell death, and vice versa, and that cell division and death are inherently stochastic processes that can each be represented by a skew and preferably lognormal probability distribution. (In this specification, the term “probability distribution” is used interchangeably with the term “probability density function”.) Accordingly, the cell population data is generated on the basis of independent probability distributions representing the distributions of times to divide and times to death of cells in a cell population. In order to generate the cell population data, it is therefore first necessary for these probability distributions to be determined, and this is achieved by the initial steps 202 to 208 of the cell population data generation process. However, as described further below, the cell population data generation process can also be used to determine one or more parameters of a cell population (which may or may not be parameters of the probability distributions), by fitting cell population data generated by the system to experimental data representing the changes in the numbers of cells in successive generations of a cell population over time. In such cases, one or more parameters of a cell population will generally be unknown, and the system determines values for these unknown parameters via a standard fitting procedure. However, for the purposes of explanation, the cell population data generation process is initially described in the context of generating cell population data where the relevant cell population parameters are known, being determined from experimental data.

The cell population data generation process begins with steps 202 and 204 that determine at least one probability distribution representing probabilities for cell death for one or more particular cell types and conditions in the absence of cell division. In the described embodiments, the probability distribution for each cell type and set of conditions is a probability density function that represents the probability density for cell death (i.e., probability density for cell death as a function of time, which provides the probabilities of cell lifetimes or ‘times-to-die’ for cells in the cell population) in the absence of cell death. The probability density function is determined applying a fitting procedure to a simulation of a dying cell population generated from a probability density function for times-to-die in order to best match actual experimental measurements of that population. Ideally, the experimental conditions are such that cell division is totally absent, and preferably the conditions are such that the rate of cell division is at least substantially absent by comparison with the rate of cell death. However, it will be appreciated by those skilled in the art that at least some degree of cell division is likely to be occurring during such an experimental measurement.

In practice, the degree of cell division will affect the accuracy of the resulting probability distribution, but even probability distributions determined by fitting simulations to experimental data obtained under far from ideal conditions where substantial cell division is competing with cell death have been found to be useful. In any case, the resulting probability distribution is assumed or deemed to represent the probabilities for cell lifetimes (or, equivalently, cell death) in the absence of cell division. As described below, these comments apply equally to the measurement of cell division.

As indicated above, the probability distribution is determined by simulating the decreasing size of a cell population over time in the absence of cell division. For example, when naive T or B lymphocytes are purified from lymphoid tissue and placed in tissue culture without stimulation, they progressively die by apoptosis, apparently from the absence of homeostatic survival signals that are present in vivo. To determine a probability distribution representing probabilities for cell death, small resting B cells from spleen/lymphnode can be placed in culture under different conditions and their viability measured by propidium iodide uptake at step 202. Cell numbers can be counted by reference to beads, as described in Deenick.

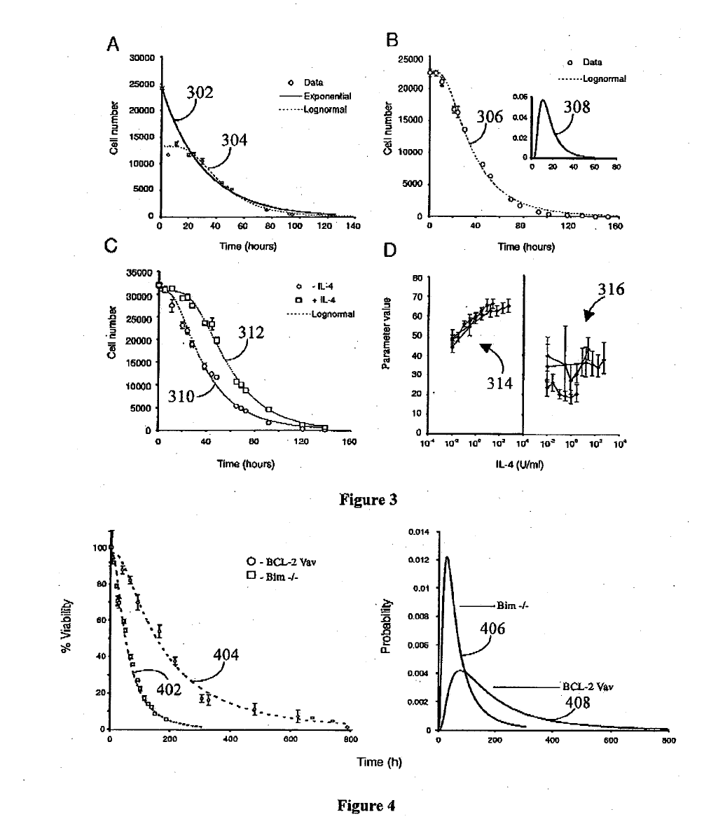

As shown in FIG. 3A, cell loss appears to follow an exponential decay function 302, consistent with a constant probability of dying over time. However, deviations from exponential decay 302 become apparent if many data points are measured. These deviations fall into two classes. Often, a very rapid loss of cells is observed over the first 6 hours, before viability stabilises, as shown in FIG. 3A, where the cell population nearly halves from about 25,000 to about 13,000 in this period. However, this initial loss is affected by the manner of preparing cells; for example, B cells isolated from lymphnode prepared quickly do not exhibit this initial loss, as shown in FIG. 3B. However, FIG. 3B clearly illustrates a second deviation from exponential decay, where an approximately exponential-like loss of cells over time is preceded by an initial delay of almost no cell loss. This delay is also evident in FIG. 3A in the (˜20 hour) time period immediately following the very rapid initial ‘mechanical” cell death related to cell preparation procedures.

The cell population data generation process represents the times to die of cells in a cell population by a lognormal probability distribution, although other probability density functions with similar long-tail characteristics, such as two-parameter skew, gamma or Weibull distributions can alternatively be used to accurately simulate the experimental data, and each may find application in different situations. A variable t is said to be lognormally distributed if its natural logarithm ln(t) is normally distributed. Accordingly, the lognormal probability distribution representing time-to die is equivalent to a normal probability distribution representing ln(time-to-die).

At step 204, the two parameters of the lognormal probability distribution, namely the mean μ and standard deviation σ, are determined using a standard fitting procedure (the Matlab fmincon function) that varies μ and σ to obtain the closest match between the corresponding lognormal survival curve (i.e., the simulated ‘survival curve’ representing the decreasing size of the cell population over time, the curve being generated from a lognormal probability distribution representing probabilities for times to die with distribution parameters μ and σ) and the experimental data. (In this specification, a survival curve or function is said to be ‘lognormal’ if it is generated from a lognormal probability distribution.) As shown in FIGS. 3A and 3B, the resulting lognormal survival curves 304,306, (the latter generated from the lognormal probability distribution 308 representing time to die shown in the inset to FIG. 3B) accurately represent the observed declines in the two cell populations over time, once the very rapid mechanical death in FIG. 3A is ignored.

Depending on the user's requirements, it may also be desired to determine one or more parameters of one or more probability distributions representing times to die of cells subject to one or more signals. For example, the cytokine Interleukin 4 (IL-4) affects B cell viability without stimulating cell division via the upregulation of the anti-apoptotic molecule Bcl-x1. FIG. 3C shows two survival curves of B cells isolated from spleen and cultured either alone (circle data points and left curve 310) or with saturating IL-4 (square data points and right curve 312). The excellent agreement between the experimental data points and the corresponding lognormal survival functions 310,312 generated by the system confirm that the decreasing size of a cell population in the presence of influencing signals such as IL-4 can also be accurately represented by lognormally distributed probabilities for times to cell death.

As shown in FIG. 3D, increasing the IL-4 concentration increases the mean time to die μ 314 but not its variance σ² 316, where the error bars represent 95% confidence intervals assigned using a Monte Carlo simulation. This indicates that time to death is not age independent, but is capable of being programmed for a particular time and altered by signals such as IL-4. Further evidence that the time of death follows an age-dependent distribution, rather than an age-independent exponential, is provided by modulating the crucial survival proteins bim and bcl-2. As shown in the left-hand graph of FIG. 4, the survival curves of B cells from bim deficient (left curve 402) or bcl-2 overexpressing (right curve 404) mice are accurately generated from respective lognormal probability distributions (shown in the right hand graph of FIG. 4 by curves 406 and 408), with mean times to die extended to 81 hours and 234 hours, respectively. This illustrates that the expression of anti-apoptotic molecules contributes to the setting of the mean time to death, rather than controlling a constant ‘probability’ of dying over time.

Once the parameters for at least one probability distribution representing times to die have been determined at steps 202 and 204, at steps 206 and 208 a similar procedure is used to determine at least one probability distribution representing the distribution of times to divide in a cell population (i.e., cell division) in the absence of cell death. As described above in relation to measuring cell death, it will be appreciated by those skilled in the art that in practice experimental conditions are unlikely to result in the complete absence of the competing process of cell death. Nevertheless, the resulting probability distribution is assumed or deemed to represent the probability distribution for cell division in the absence of cell death.

At step 206, the growth of at least one cell population over time is measured under conditions where only one division is possible, and preferably in the substantial absence of cell death. For example, when resting T and B cells are polyclonally stimulated in vitro, the time taken to enter into the first round of division is longer than for subsequent divisions. Resting cells take time to ‘awake’ from quiescence and accumulate the necessary levels of cell division components. The average time a cell takes to divide can be varied, apparently continuously. This can be monitored by the use of a mitosis inhibitor such as colcemid. Cells stimulated in the presence of this drug pass unimpeded through their first S phase, but are arrested in G2/M and no further divisions occur. By pulsing for short periods with ³H-thymidine at numerous time points after culture, a measure of the number of cells in the S phase can be obtained, as described in P. D. Hodgkin, N. F. Go, J. E. Cupp, M. Howard, Cell Immunol. Vol. 134, 14 (1991).

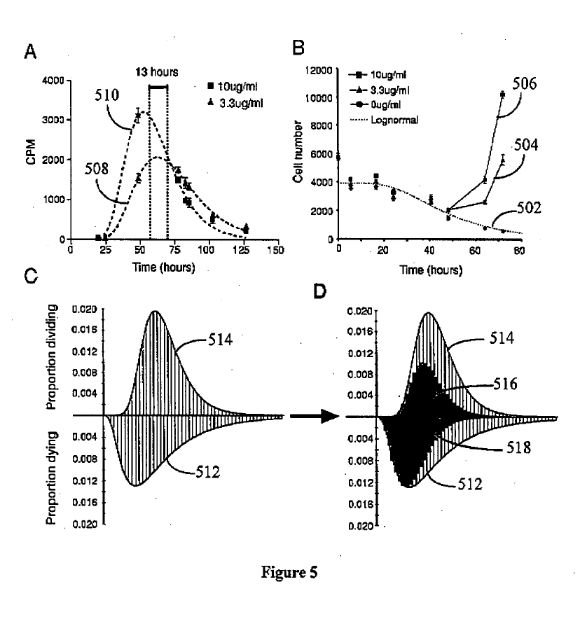

For example, resting B cells were placed in culture with 500 U/ml IL-4, and either 10 μg/ml, 3.3 μg/ml, or 0 μg/ml α-CD40. B cell proliferation was measured by flow cytometry. After 48 hours, cell numbers increased in a dose dependent manner. Prior to 48 hours, cell numbers remained the same regardless of stimulation level. FIG. 5B is a graph of the changing size of the population of B cells stimulated to divide with α-CD40 and IL-4 and harvested using the colcemid technique at 0 μg/ml (lowest curve 502) 3.3 μg/ml (middle curve 504) and 10 μg/ml (upper curve 506). As shown in FIG. 5A, the mean time to divide varies with α-CD40 concentration, illustrating the continuous nature of time modulation that can be achieved. The broad variation in times to divide revealed by this method is characteristic of a wide variety of biological systems, and is accurately characterised by a lognormal distribution in each case.

As described above, experimental data on the growth and decline of a cell population demonstrates that these processes in isolation are stochastic in nature for individual cells, but can be accurately represented by skew probability distributions, and in particular by lognormal probability distributions defining the distributions of times to divide and times to die in a cell population. By at least substantially isolating cell death and cell division from the competing effects of cell division or death, respectively, the underlying probability distribution that characterises each process can be determined. Having determined these underlying distributions at steps 202 to 208, they can be used to predict the overall outcome from a population of cells subject to simultaneous and competing division and death events.

A convenient way to represent the competing processes of cell death and cell division is to plot, on a single graph, both probability distributions 512,514 but with the probabilities of times to die 512 plotted on the negative y axis, as shown in FIG. 5C for B cells stimulated with 10 μg/ml-CD40 and 500 U/ml IL-4. The shaded areas 516,518 in FIG. 5D represent the net result of these competing processes, with the upper shaded area 516 representing the probability that a cell will divide in each corresponding time interval, and the lower shaded area 518 representing the probability that it will die. Here we emphasise the distinction between (i) the probability that a cell will die in a given time interval, and (ii) the probability that its time to die lies in that interval. The first probability (i) is given by the second probability multiplied by the probability that the cell's time to divide does not occur before its time to die.

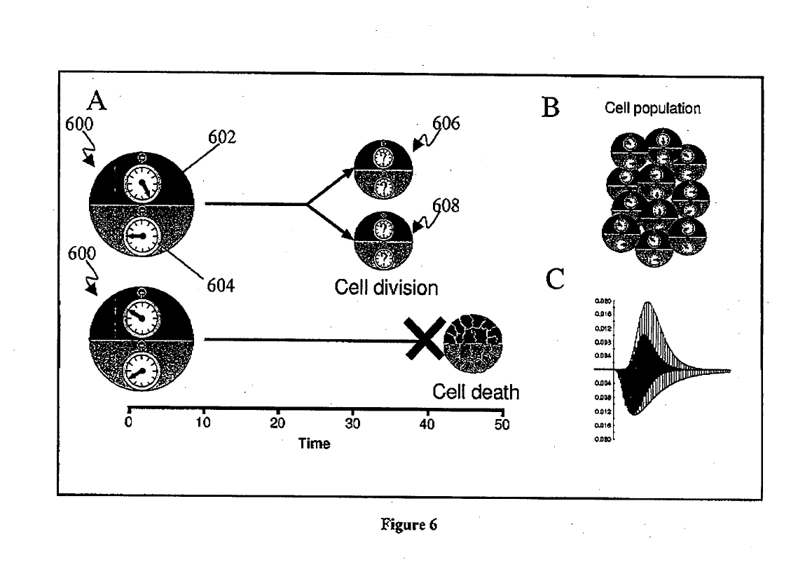

As shown in FIG. 6, each cell 600 can be considered to include two independent components controlling the time to that cell's division (represented by the upper clock 602) and the time to its death (represented by the lower clock 604). The fate of each cell is thus determined by the times contained within each part of the cell machinery. If the time to divide represented by upper clock 602 occurs before the time to die represented by lower clock 604, then the cell will proceed through cell division to produce two new cells 606,608, each with their own internal clocks, as illustrated in the upper part of FIG. 6A. Conversely, if the time to die occurs before the time to divide, then the cell 600 dies, as illustrated in the lower part of FIG. 6A. However, the times to divide (or die) within a population of cells are not identical, but instead are distributed stochastically, as illustrated in FIG. 6B. The distribution of these times is accurately represented by a skew probability density function such as the lognormal. The means of these probability distributions can be controlled by external signals that alter the likelihood of cells in the cell population dividing or dying. Assigning probability distributions to the variations in times to divide and times to die allows the number of cells dividing and dying in each time interval to be simulated, and thus quantified.

For example, lymphocytes placed in culture with a polyclonal stimulus are subject to simultaneous motivations to die or divide, and each of these competing processes can be independently regulated by extrinsic signals. However, as shown in FIG. 5B for B cells stimulated with α-CD40 and IL-4, the rate of cell death is not affected for at least the first 30 hours, the time at which the surviving cells begin dividing. This confirms that the survival and division machinery inside each cell can be regarded as independent entities. Each cell placed in culture has its own time to die, and these times are distributed in the population according to a lognormal distribution. Adding a mitogenic stimulus activates the cells, effectively imposing a ‘time to divide’ within each cell that also varies in the population according to a lognormal distribution. The two timed ‘processes’ within the cell, time to die and time to divide, are independent, and whichever outcome is reached first determines the fate of that cell.

When asserting that times to die and divide are independent, it is important to clarify two potential complications. The first is the likelihood that a proportion of cells die as a consequence of rare irrepairable errors in the replicative machinery. This form of death is not considered by the cell population data generation process because it is a consequence of errors in the cell machinery. The second is that receptor mediated signals, or internal regulatory molecules, may alter both the times to divide and the times to die, giving the appearance of linking the two processes. Nevertheless, this does not negate the fundamental independence of the two processes.

The two probability distributions (probability density functions) characterising times to divide and times to die in a cell population can be represented thus:

$$[ \begin{matrix}ϕ ( … ) \\ Φ ( … )\end{matrix} ]$$

with φ representing the distribution of times to divide and Φ the distribution of times to die, while the ellipsis ( . . . ) represents parameter values (being μ and σ if the distributions are lognormal distributions). The cell population data generation process described herein can use other forms of probability distribution, but the lognormal probability density function has been found to provide an accurate representation of experimental data. In particular, the probability distribution governing time to first division is better approximated by a lognormal than other skew distributions, such as Weibull, gamma and beta distribution. In contrast, time to death can be represented by gamma or Weibull distributions with similar accuracy to the lognormal distribution.

In the absence of cell division, the average number of cells that die N^{die} in the time interval Δt around a time t is given by:

N^{die}(t)=N₀×Φ(t)·Δt

Similarly, in the absence of cell death, the average number of the original population of N₀ cells that divide n^{div} in the time interval Δt around time t is given by:

n^{div}(t)=N₀×φ(t)·Δt

When cells in a population divide, the new cells thus created can be considered to define a cohort of child cells that is referred to herein as a division class or division. Thus the immediate child cells of the original ‘parent’ cells define one division (the ‘first’ division), and the immediate children of those child cells (i.e., the grandchildren of the parent cells) define a second division, and so on. For consistency, the original cohort of ‘parent’ or starting cells is referred to as the zeroth division.

Given the distribution type and parameter values for the distributions of times to die and divide, and the number of starting cells (N₀), the net number of cells of the zeroth division that divide n^{div} and die N^{die} in the time interval Δt around time t are given by:

n^{div}(t)= [symbol] ·(1−∫₀^{t}Φ(t′)dt′)·φ(t)·Δt

N^{die}(t)= [symbol] ·(1−∫₀^{t}φ(t′)dt′)·Φ(t)·Δt.

The effect of an external stimulus on each distribution parameter (i.e., the mean and variance of each distribution) can be determined, as described above. The dependence of a parameter on the concentration of a given stimulus can also be determined, or if already known, can be provided as input to the system, either as an analytical formula (by identifying one of a plurality of predefined formulas known to the system and the corresponding set of parameters for that equation), or by providing the name of a data file stored on the hard disk of the system containing XY pairs representing respective values of that particular parameter for respective concentrations, whereby the system determines the value of the parameter for a given concentration by interpolation or by fitting a polynomial or other function to that data.

The above formulae apply to the activation of a homogeneous cell population where all cells will eventually divide if they don't die first. However, in reality not all cells in a population will eventually divide if they avoid death. Some may be non-responsive to the stimulation, for example they may lack an effective receptor. Alternatively, cells may clearly respond, as evidenced by cell size increases or expression of activation markers, but not go on to divide. For the purpose of determining cell numbers, the cell population data generation process allows a user to define the proportion of the population that can divide in response to the stimulation provided. The parameter defining the dividing proportion of the cell population is referred to as the progressor fraction p_{div}. The parameter p_{div} effectively divides the starting population of N₀ cells into two groups, the dividers (the number of which is N₀^{div}=N₀×p_{div}) and non-dividers (N₀^{nondiv}=N₀×(1−p_{div})). The non-dividers can be further categorized as non-responders or responders if desired. To determine the number of cells that either die or divide within a discrete time interval, a survival term (i.e., a probability density function and associated mean and variance parameters, representing times to die) can be defined for each group that is different to that of the dividing group. The probability density function for non dividing, non-responding cells is written as Φ^{ndnr}, and the probability density function for non-dividing responders is written as Φ^{ndr}. In the general case, the probabilities for cell division and death in a cell population can thus be represented by:

$$[ Φ , {Φ}^{{ndnr}^{ϕ}} , {Φ}^{ndr} ]$$

where the proportions of cells which are non-dividing non-responders (P_{ndnr}), non-dividing responders (P_{ndr}), and precursors (P_{div}) are related by

p_{ndnr}+p_{ndr}+p_{div}=1.

The number of cells that die in the interval Δt is therefore:

N^{die}(t)=N₀·(p_{ndnr}·Φ^{ndnr}(t)+p_{ndr}·Φ^{ndr}(t)+p_{div}·(1−∫₀^{t}φ(t′)dt′)·φ(t))·Δt

Although this represents the most general case, to simplify the discussion below in what follows, it is assumed that the death probability densities for all cells are identical. However, in the general case, the distribution of times to death of progressor and non-progressor cells can be different, thereby requiring them to be determined separately.

The above formulae determine the numbers of cells in the zeroth division that enter division over time. In order to predict the number of cells in each division at any time, it is necessary to account for the fate of cells after they divide the first time. Lymphocytes typically progress through a series of division rounds much more quickly than they took to enter the first division. Furthermore, the inter-mitotic times through subsequent divisions are not affected by the time taken to reach first division. BrdU labelling also indicates that average division times are not shorter among cells that have reached later divisions. Thus, there is no evidence for a significant inheritance of division times by lymphocytes, as has previously been noted in studies of mother-daughter inheritance and for inheritance of key growth factor receptors by T cells. The results described above are consistent with division times through subsequent divisions being variable and affected by signal strength in like manner with the first division.

Based on the lack of inheritance of division times noted for dividing lymphocytes, the cell population data generation process represents cell division and death by respective skew probability distributions, not only for the first division, but also for subsequent divisions. An individual cell will, upon division, ‘erase’ the values of the parent cell's times to divide and die, and adopt new values drawn from the appropriate distributions.

In the general case (but assuming that all cells can divide), each division is assigned its own pair of probability distributions for cell division and death:

$${[ \begin{matrix}{ϕ}_{0} ( … ) \\ {Φ}_{0} ( … )\end{matrix} ]}_{0} \vert {[ \begin{matrix}{ϕ}_{1} ( … ) \\ {Φ}_{1} ( … )\end{matrix} ]}_{1} \vert … \vert {[ \begin{matrix}{ϕ}_{n} ( … ) \\ {Φ}_{n} ( … )\end{matrix} ]}_{n} .$$

Given probability densities φ and Φ and associated parameters, the cell population data generation process uses these to determine the number of cells that divide and die in each division class at any time, as well as the cumulative number of cells in each division class, where a division class is a specific generation of cells (e.g., parent cells, child cells, grand child cells, and so on).

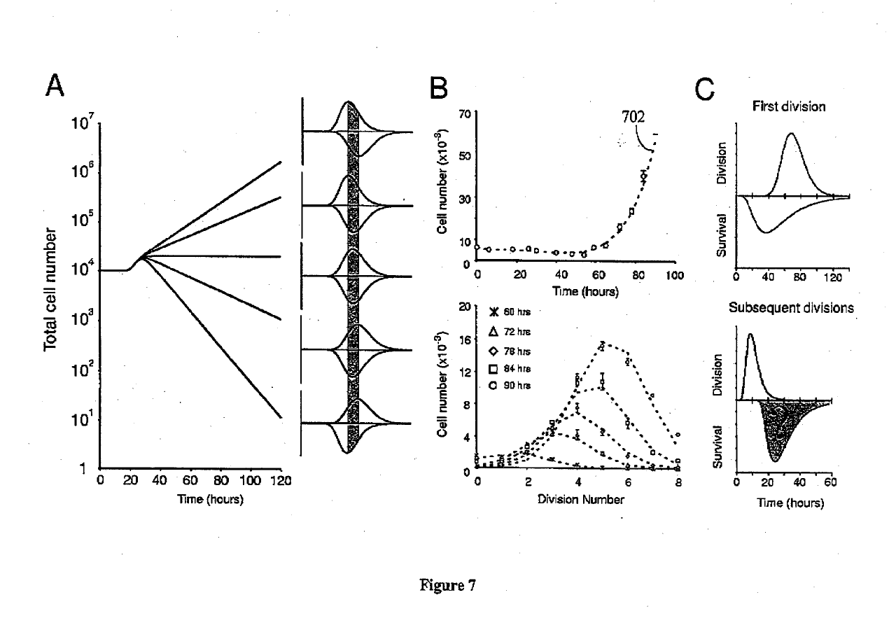

To illustrate the power of the cell population data generation process, the left-hand graph of FIG. 7A shows the results generated by the process for five different sets of input parameters, where the probability density functions are selected to be lognormal and the parameter values (i.e., means and variance) for those distributions are kept constant after the first division. The probability distributions for the original cells and also those for the time to divide and time to die of subsequent generations of cells were known and provided as input. The simulated total numbers of live cells as a function of time are plotted in the left-hand graph of FIG. 7A for various values of μ and σ for the probability distributions for cell division and survival, as shown in the five graphs in right-hand side of FIG. 7A. (values for μ−descending order: φ_{i>0} 9, ψ_{i>0} 11, 2: φ_{i>0} 9 ψ_{i>0} 10.5, 3: φ_{i>0} 10 ψ_{i>0} 10.5, 4: φ_{i>0} 11, ψ_{i>0} 10.5, 5: φ_{i>0} 11, ψ_{i>0} 9. s is kept constant at 0.2 for all plots). Small adjustments in μ of less than 20% (represented by the shaded area of the right hand side of FIG. 7A) lead to large net changes in cell proliferation.

Lymphocytes were labelled with the fluorescent marker CFSE and stimulated with 10 μg/ml-CD40 and 500 U/ml IL-4. The fluorescent marker is taken up by a cell only during division, with each generation effectively diluting the marker. Consequently, the generation (i.e., division class) of a cell can be determined by measuring its fluorescence intensity. Cells were harvested at different times and the total cell number as well as number of cells in each division determined, as shown in the two graphs of FIG. 7B. The system generated accurate fits to the data, as shown by the dashed lines, to determine the mean and variance of the time to divide distribution for child cells. Mean and SEM (standard error of mean) values of triplicate samples are shown by the data points in FIG. 7B. The resulting distributions of times to divide and time to die are shown in FIG. 7C for the first generation in the upper graph and for all other generations in the lower graph (i.e., parent or starting cells). Using the data available, the solution for subsequent division survival could not be accurately constrained.

The results of FIG. 7A illustrate how quite small changes in mean times to die and divide can vary the overall evolution of a cell population from one of rapid growth to one of rapid cell loss. The extreme sensitivity to small changes in distribution parameters is emphasized by noting (in the lower graph of FIG. 7B) the 300-fold difference in cell number after 80 hours that results from a simultaneous lengthening of time to divide and shortening of time to die by only 20%.

The cell population data generation system generates total cell numbers at any desired time after initiation of culture, the number of cells in each division, and the numbers of dead cells and their times of death. As described above, the system performs a fitting procedure to determine the values of one or more parameters that best fit experimental data from CFSE division tracking experiments that determine total cell number and cells per division for both live and dead cells. In FIG. 7B, CFSE and beads were used to determine the number of B cells in each division at different harvest times following exposure to α-CD40 and IL-4. The dashed line 702 is the best fit generated by the system, illustrating the excellent fits that can be achieved. Nevertheless, such fitting to live cell numbers alone does not necessarily define a unique solution for subsequent division and death parameters, because faster division times can to some extent be counteracted by earlier mean times to die, and thus a number of different solutions may be possible in some instances. However, it has been found that a unique solution can be determined if the numbers of dead cells in each division are also included in the data set to which the parameters are fit. Unfortunately, this information is difficult to obtain with the CFSE method. Consequently, it is preferred to apply the system to experimental systems more dependent on death to validate the cell population data generated by the system, as described below.

Regulating Number of Divisions

Lymphocytes stimulated in vitro, or in vivo, do not divide indefinitely after stimulation, but rather the number of consecutive cell divisions they undergo can vary. For example, when α-CD40 is used to stimulate B cells and then removed before the cells have entered their first division, the cells subsequently divide 3-4 times. In contrast, CD8 T cells divide at least 8 times following stimulus removal. Thus, initial stimulation can initiate a variable number of subsequent division rounds—possibly by accumulating an excess of mitosis triggering molecules that dilute with division. Alternatively, cell division may be dependent upon external growth factors that eventually dissipate. When cells stop dividing, they usually die rapidly. The cell population data generation process explains this behaviour in a very simple manner. For a rapidly dividing population, the division time is usually shorter than the time to die and the cells are thus more likely to divide; however, if the impetus to divide ends, then the underlying time to death is revealed.

The rate of death after cells cease dividing reveals the underlying survival distribution of the population. The cell population data generation system includes the ability to vary the number of divisions taken by cells before they stop dividing. This is achieved by allowing the proportion of cells that divide in each division to diminish through progressive division numbers according to a truncated normal survival function.

As cells will vary in the division number at which they stop dividing, to determine the progressor fraction at each division, P_{div}_{ᵢ}, the system uses a truncated normal distribution, with mean μ and standard deviation σ, and initial probability p_{div1} (the value of p_{div} for the first division):

$${pdiv}_{i} = {pdiv}_{1} \cdot ( 1 - \frac{{D}_{i} - {D}_{1}}{1 - {D}_{1}} )$$

$$where$$

$${D}_{i} = {\int }_{- ∞}^{i - 1} P ( x , μ , σ ) d x$$

$$and$$

$$P ( x , μ , σ ) = \frac{1}{σ \sqrt{2 π}} {e}^{{( x - μ )}^{2} / ( 2 {σ}^{2} )}$$

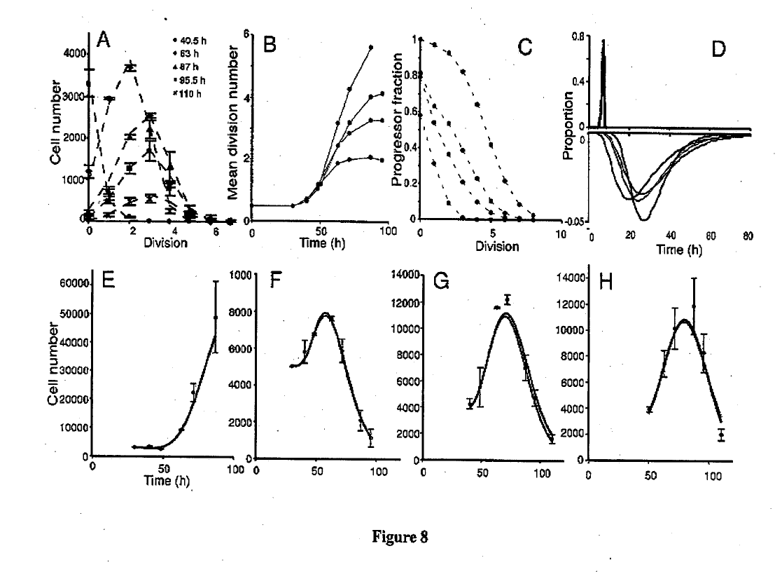

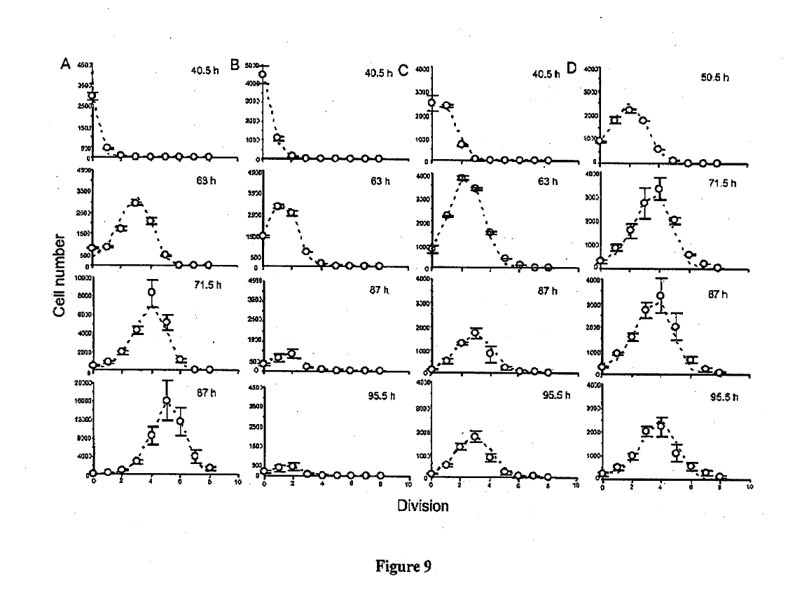

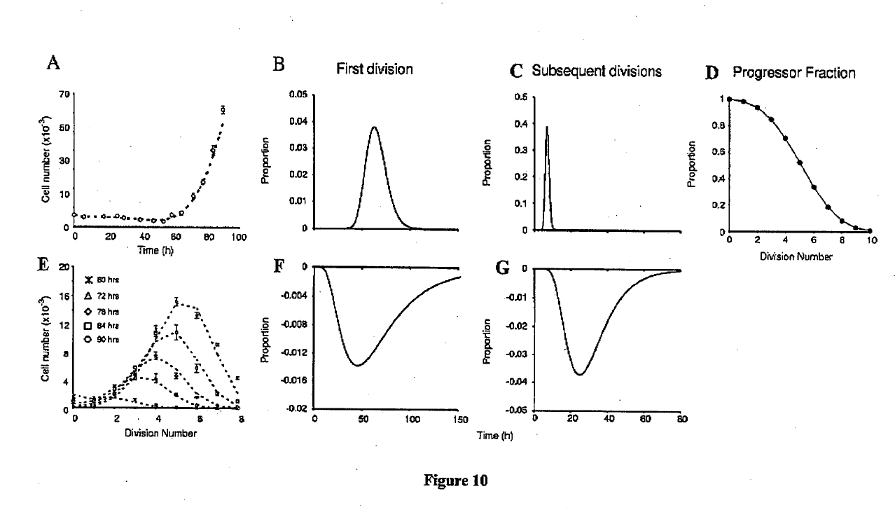

FIG. 8 shows experimental data for B cells stimulated by α-CD40 and IL-4, together with corresponding cell population data generated by the cell population data generation process and incorporating the diminishing progressor fractions (see FIG. 8C), as described above. By removing the stimulus after 40 hours, B cells divide a limited number of times and begin dying (FIG. 8A). Exposure to 30, 40 and 50 hours of stimulation results in progressively more division rounds before cells stop dividing and start dying at a high rate (FIG. 8B). The system can fit this data extremely well, for both live and dead cells, with mean division numbers of approximately 2, 3.3 and 4.1 for 30 (green), 40 (blue) 50 (red) hours of, and constant (black) stimulation, respectively (FIG. 8B) (The number of cells per division for each group is shown in FIG. 9). As shown in FIG. 8D, the rate of cell death is consistent with a lognormal probability density with parameters μ and σ that do not appreciably alter with the duration of stimulation. Thus, the basic assumptions made by the system apply extremely well to this complex experiment. When the progressor fraction is allowed to vary with division number in the simulation of the experimental data shown in FIG. 7, the system detected a progressive decrease in the progressor fraction with division number (as shown in FIG. 8C) and gave faster division times consistent with those reported in FIG. 9. The results of this reanalysis are shown in FIG. 10.

Other scenarios are envisaged where additional parameters are included in the process and the values of those parameters change with division, as described above for p_{div}. Such changes could be via internal division-linked programming, as seen for differentiation, or they could be imposed from external signals via interactions with cells or exposure to cytokines while dividing. The cell population data generation process treats both internal and external regulation of the parameters in the same manner.

A feature of the cell population data generation process is its ability to represent the effect of receptor-delivered signals as a change to one or more parameters of the process. All signals affecting cell number positively or negatively can be taken into account and their effects predicted in a quantitative manner. Similarly, the manner of signal integration, the arithmetic of adding the effect of two or more cytokine signals on each parameter, can be measured and used by the system to predict the net outcome. By measuring (at steps 202 to 208) the effects of stimuli on the different parameters, both alone and in combination, the system can generate accurate predictions of the adaptive immune response that can reproduce the effects of, for example, cytokine removal or genetic polymorphisms.

In an alternative embodiment, rather than solving for the mean behaviour of the overall population of cells, the behaviour of individual cells can be followed using an agent-based or Monte Carlo approach. In this alternative embodiment, a starting population of cells is created. The time period of interest is divided into a number of small time steps. At each time step, the behaviour of each cell is simulated by using a random number generator to draw a value of at least time to divide and time to die from each probability distribution. A cell can die, divide, receive a signal that changes its future behaviour in some way or do nothing. Summing the properties of all the simulated cells in the population gives the overall properties of the population at each time step. Both the mean and variance of the population properties can be estimated in this manner.

Branches in Proliferation and Survival Properties

The cell population data system and process have been described above in relation to single populations of cells of similar type. However, the system and process can also be applied to the cell biological process of differentiation by considering differentiation as a new ‘stochastic’ event governing cell fate by representing the time taken for a cell to differentiate within a given division round by a corresponding probability distribution. As with the times to divide or die, this probability distribution can be a lognormal, normal, or some other type of distribution. The probability distributions governing times to divide, die, and differentiate are considered to be independent, and as before the cell population data system and process maintains ‘branches’ following the fate of each new cell type, and aggregates the results to provide values representative of the total cell population.

As with the other probability distributions, the parameter values for differentiation over time can change with division number. These changes can be assigned to each division based on experimental measurement, and the changes across divisions can be expressed as a mathematical formula relating division number and corresponding parameter values.

When the system is configured to include cell differentiation, there are four possible outcomes per time interval: (i) the cell does nothing, (ii) the cell divides, (iii) the cell dies, or (iv) the cell becomes a different cell type. Cell division and death are handled as described above, except that the numbers of cells dividing, dying, or differentiating are respectively given by:

$${n}_{die} ( t ) = {N}_{0} ( 1 - {\int }_{0}^{t} ϕ ( τ ) d τ ) ( 1 - {\int }_{0}^{t} η ( τ ) d τ ) Φ ( t ) d t$$

$${n}_{div} ( t ) = {N}_{0} ( 1 - {\int }_{0}^{t} η ( τ ) d τ ) ( 1 - {\int }_{0}^{t} Φ ( τ ) d τ ) ϕ ( t ) d t$$

$${n}_{diff} ( t ) = {N}_{0} ( 1 - {\int }_{0}^{t} ϕ ( τ ) d τ ) ( 1 - {\int }_{0}^{t} Φ ( τ ) d τ ) η ( t ) d t$$

With φ(t), Φ(t), η(t), the probability distributions for time to divide, die and differentiate respectively.

The numbers of differentiated cells generated at each time interval are represented by a vector which can be input to the system as an independent line of cells with the input cells all in the equivalent of their division 0. Given parameter values and distributions for times to divide and die for the differentiated cells, the cell population data process described above is independently applied to the new cell vector, determining the numbers of parent cell types found in each division at all times, and the number of differentiated cells in each division at all times.

Additionally, the cell population process can follow cells that branch (i.e., differentiate) any number of times, either from the primary line, secondary, tertiary lines, and so on.

Broadly there are two types of differentiation events to consider. The first is a direct analogy with division; the cell chooses a time to differentiate from a probability distribution, and if that time arrives before its time to divide and its time to die, the cell differentiates. The differentiated cell then chooses a new time to die, divide and possibly to further differentiate from a new set of probability distributions, that may be the same as, or different to, the previous distributions. In the second type of differentiation event, the cell chooses a time to differentiate in the same manner, however, upon differentiation, the cell continues with the same time to die and time to divide, and possibly time to undergo another differentiation event, as before.

The parameter values for the probability distributions for each of the differentiated cell types can, in general, be different.

Accumulation of Products from Cells

By determining the number of each cell type at each time in a branching system, it is also possible to ascribe properties of effector function to the generated cells, and therefore immune outcomes. For example, a differentiated cell type might secrete a product, such as antibody, at a constant rate. Therefore, numerical integration of the numbers of this cell type over the life of the simulation can determine the total amount of antibody expected to be present in the biological system.

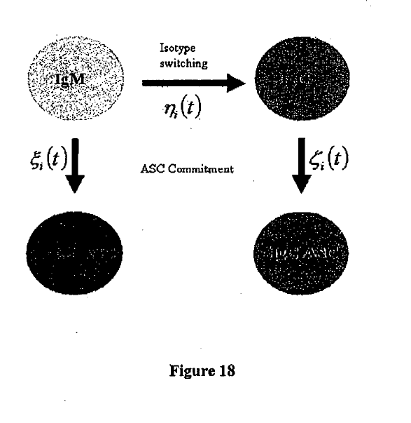

For example, consider a system of LPS stimulated B cells in the presence of IL4. All cells are initially of a type IgM non-secreting; however, at any time they can die, divide or differentiate, based on respective probability distributions. There are 4 different types of cells that need to be considered in this process, and the differentiation processes that give rise to them are illustrated schematically in FIG. 18.

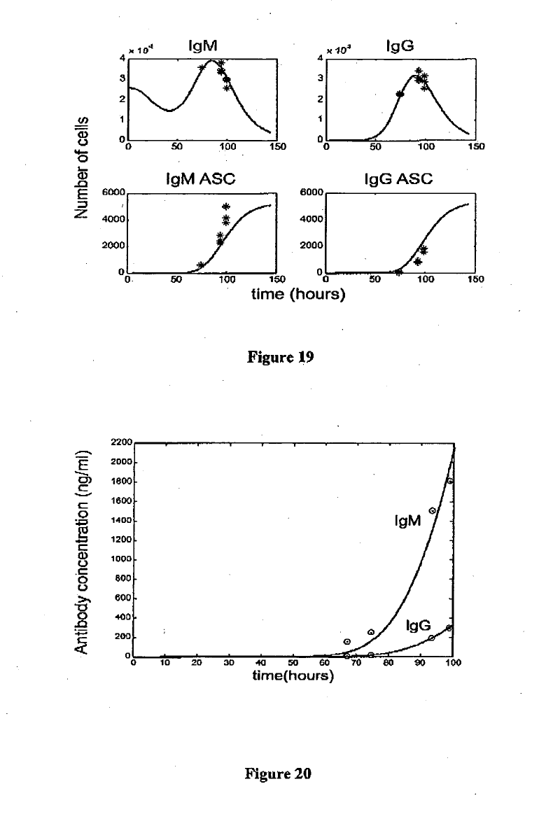

By a suitable choice of the parameters describing the various probability distributions for death, division and differentiation of the different cell types in each generation, the system can accurately predict the total number of each type of cell alive at any given time. As before, the parameters are obtained by fitting to experimental data. FIG. 19 shows a comparison of experimental data and simulated results.

In this example, there are two types of differentiation process: isotype switching, and commitment to form antibody secreting cells. The differentiation to antibody secreting cells is a process directly analogous to division, with the subsequent differentiated cell choosing new times to die and divide from probability distributions that may be the same or different to the distributions for the cell prior to differentiation. In the case of isotype switching, however, the switched cell continues with its previously chosen death, division and differentiation times.

In this example, there are two cell types that each secrete an antibody of a different isotype into the cell supernatant. Using the simple assumption that these cells secrete antibody at a constant rate, it is possible, by appropriate choice of these rates, to accurately predict the concentration of each antibody type in the supernatant as a function of time. Again suitable secretion rates can be obtained by fitting to experimental data. A comparison of experimental data and simulated results is shown in FIG. 20.

High Throughput Drug Screening

The cell population system can be applied to any proliferating and/or differentiating cell system. The parameter values defining the distributions of times to divide, to die, and to differentiate, and the number of divisions to undergo, summarise the behaviour of a large number of intracellular procedures. These model components represented by probability distributions can be thought of as separate cellular machines and the experimentally measured distribution parameter values are indicative of the operation of those machines. Drugs and inhibitors of immune processes that act on one or more of these cellular machines are potentially useful for immune modulation. By undertaking quantitative time series experiments with CFSE-labelled cells cultured in vitro, the effect of drugs on independent internal machines can be determined. Thus the cell population system and process can be used to facilitate the evaluation and identification of suitable modulatory drugs and treatments. The ability of the cell population system and process to determine the effect of a drug on proliferation and survival can be used to predict the outcome of using the drug in vivo, providing a useful pre-screening method as to the utility of the drug.

Evaluating and Predicting Drug Synergies

When two drugs that affect growth and/or survival and/or differentiation are used in combination, they can have a more powerful effect than either alone. In practice, finding suitable synergistic drug combinations can require an immense amount of combinatorial testing. The cell population system can be used to determine the effect of single drugs, and then, knowing the independent parameter changes, the system can determine a predicted net change of any number of combinations of those drugs. Similarly, the cell population system can be used to predict which combinations of inhibitors that have small effects at low concentrations will add to provide a powerful overall difference in immune outcome.

Identifying the Impact of Genetic Mutations and Polymorphisms.

Just as a drug can affect separate cellular machinery components, genetic mutations or polymorphisms that affect the immune response can also be isolated to determine their effect on independent cellular machinery components. As for the use of drugs, the impact of differences in two or more cellular machinery components can be shown to add up to weaknesses or strengths in immune responsiveness using the cell population system. This can be applied to human in vitro diagnostic tests. For example, T or B lymphocytes isolated from human blood can be stimulated and analysed for intrinsic proliferation properties. Knowledge of how functional differences correlate with some diseases, such as those of autoimmune nature, or immunodeficiencies, allows such tests to predict susceptibility to disease and tailor an appropriate therapy.

The cell population data generation system and process have been described above in terms of the immune response. However, many other general biological processes are controlled by the regulation of growth and survival, including embryogenesis, organogenesis, and hematopoiesis. Intrinsic programming that includes variation in burst size, and stochastic division and death rates may play an important role in these processes.

In this context, differentiation of cells can be linked to division number, allowing a range of different cell types to be fashioned by internal stochastic mechanisms.

### EXAMPLE 1

### Evaluating the Combination of Functional Polymorphisms on Antibody Production

The antibody response of the autoimmune strains NZB and NZW and their F1 progeny were examined. It is known that the F1 combination has a more severe autoantibody producing phenotype than either parent.

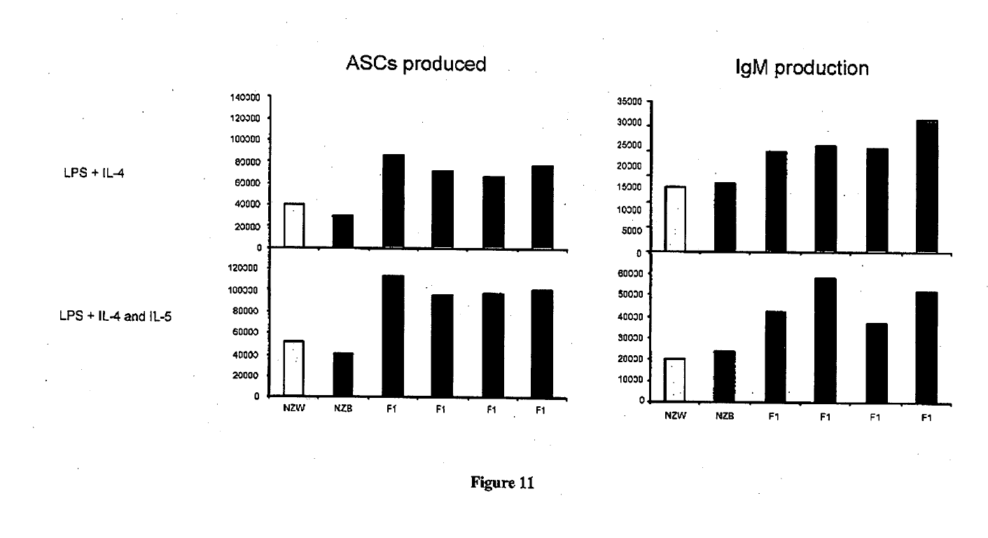

As shown in FIG. 11, a similar unusual outcome was found to occur when B cells were stimulated with the B lymphocyte stimulatory agent lipopolysaccharide (LPS) in vitro. That is, the F1 B cells generate more antibody-producing cells, and therefore more antibody, than either parent alone. The cell population system was used to identify the reason for this quantitative disparity associated with autoimmunity.

Proliferation and Survival

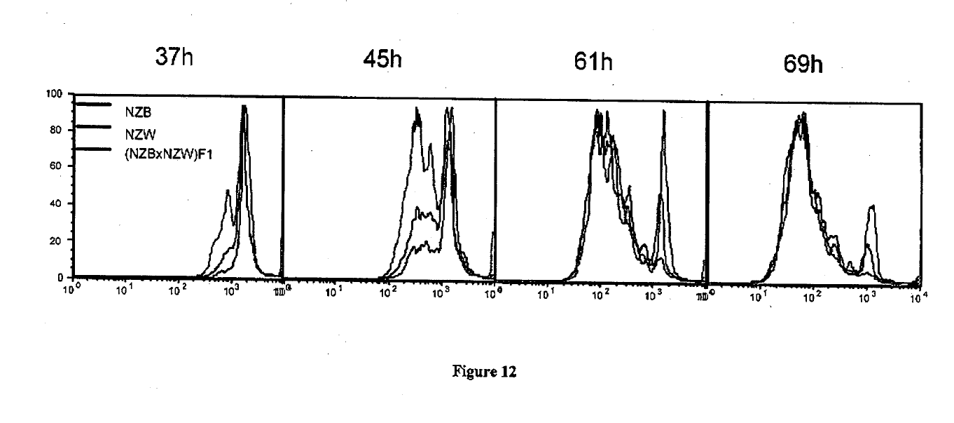

To identify quantitative differences in proliferation and survival for these cells when stimulated with LPS, CFSE labelling was used to follow the cell generation over time using flow cytometry. FIG. 12 shows the resulting CFSE profiles overlaid for each B cell source for harvest times of 37, 45, 61, and 69 hours. These data were analysed and represented as cell numbers per division. The cell population system was then used to determine parameter values that would generate equivalent data sets.

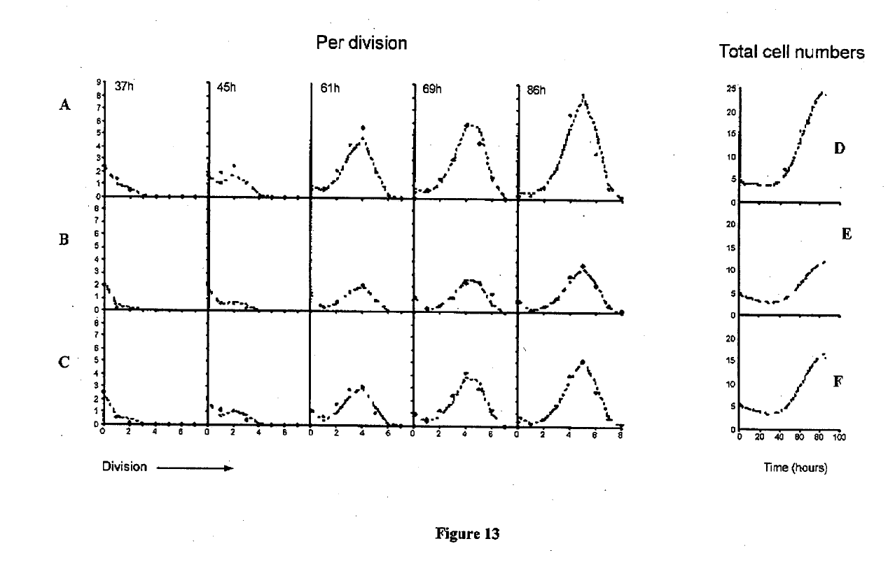

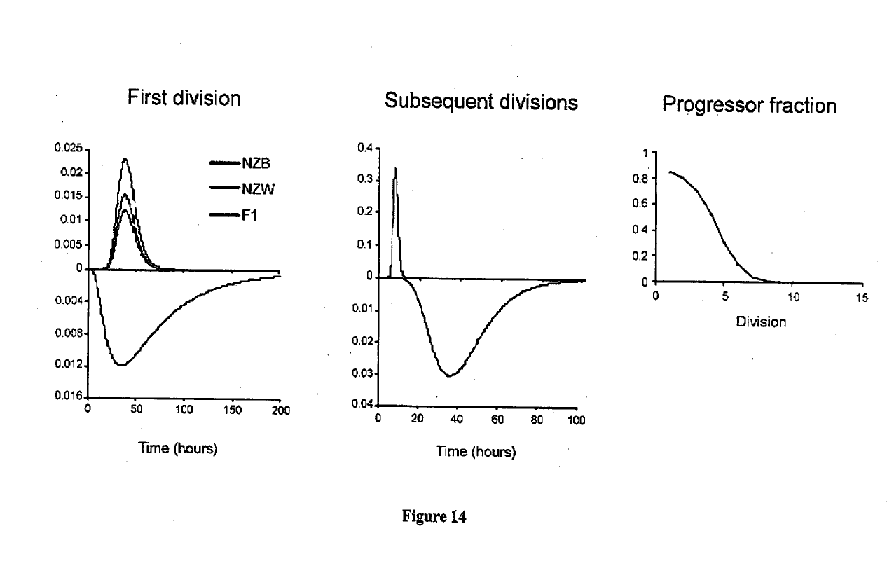

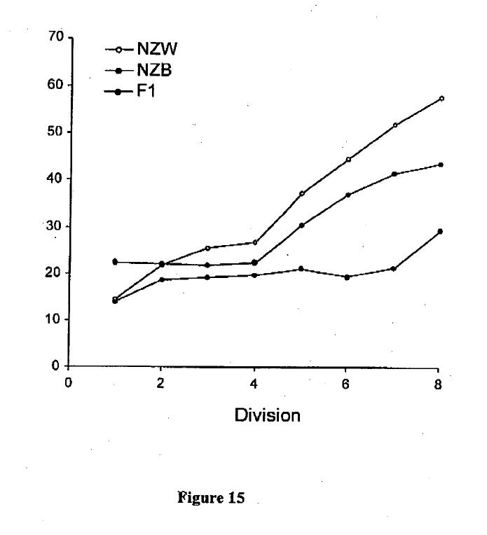

The results of fitting each data set are shown in FIGS. 13A to 13F, where FIGS. 13A to 13C each include five graphs of the distribution of cells with division for each of the five harvest times, for NZB, NZW, and NZB×NZW F1, respectively. FIGS. 13D to 13F are corresponding graphs of the total cell numbers as a function of time for the respective B cell types. FIG. 14 shows the three resulting optimum combinations of interleaving probability distributions that were the results of fitting the three respective data sets. This analysis revealed that the only parameter of the proliferation and survival cellular components affected by the genetic differences between NZB and NZW was the progressor fraction of cells responding and entering the first division (NZB=0.529, NZW=0.277). All other parameters were identical. When F1 B cells were examined, the proliferation parameters were again identical to each parent except that the fraction of responding cells was intermediate between that of the parents ((NZB×NZW)F1=0.355).

Differentiation

B cells stimulated by LPS undergo a number of branching differentiation processes where the probability of making the change varies with successive divisions. These processes are the generation of isotype switched cells that express IgG1, and a separate event, the generation of antibody secreting cells (ASC) that can be detected by expression of syndecan-1 on the cell surface. The rate of switching per division was monitored on CFSE labelled cells and was similar for NZB, NZW and the F1 progeny. However, as shown in FIG. 15, the probability of developing into ASC was different between the two parent strains, being greater for NZW than for NZB. Again, the F1 exhibited an intermediate rate between the two parents.

Determining the Net Outcome

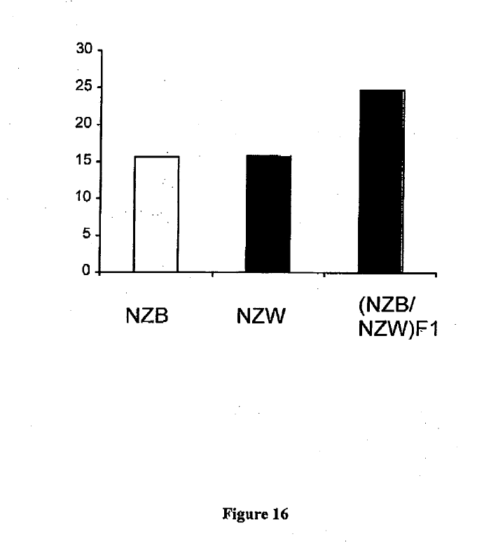

The cell population process therefore identified two independent genetic effects altering only two parameters: the frequency of cells entering first division, and the division-linked probability of developing into ASC. The cell population process was used to predict the net effect of these two changes when combined into intermediate levels within the F1 progeny. The predicted result is shown in FIG. 16, and clearly predicts the same trends seen in the experimental results shown in FIG. 11.

This experiment illustrates how measuring the parameter values for independent mechanical processes can be used with the cell population process to sum immune outcomes that can predict autoimmune susceptibility.

### EXAMPLE 2

### Screening Drugs for Effects on Functional Parameters and Predicting Combinatorial Outcomes on Antibody Levels

The B cell response to LPS in vitro can be accurately predicted as described above. The response undergoes lognormal times to divide, division cessation after a series of divisions, and subsequent death, all of which can be summarised by a series of corresponding parameter values. During each division, a proportion of cells form a branch (i.e., differentiate) to IgG3 positive switched cells, and both unswitched and switched cells can differentiate to an antibody secreting cell branch that secretes Immunoglobulin at a constant rate. This response can be used as a surrogate for the in vivo antibody response.

Inhibiting the Antibody Response

LPS-stimulated B cells were exposed to concentrations of 5-20 uM of each of a 100,000 pharmacological agent compound library and the resulting effects on antibody secretion were measured. Reductions or increases in antibody levels are indicative of an effect on one, or a combination, of the cellular machinery components described by the parameters of the model. Compounds with effects on antibody secretion were further examined using quantitative methods and categorised into those with effects on proliferation parameters only, isotype switching parameters only, ASC differentiation parameters only, and antibody secretion parameters only.

Examples of Targeted Independent Inhibitors

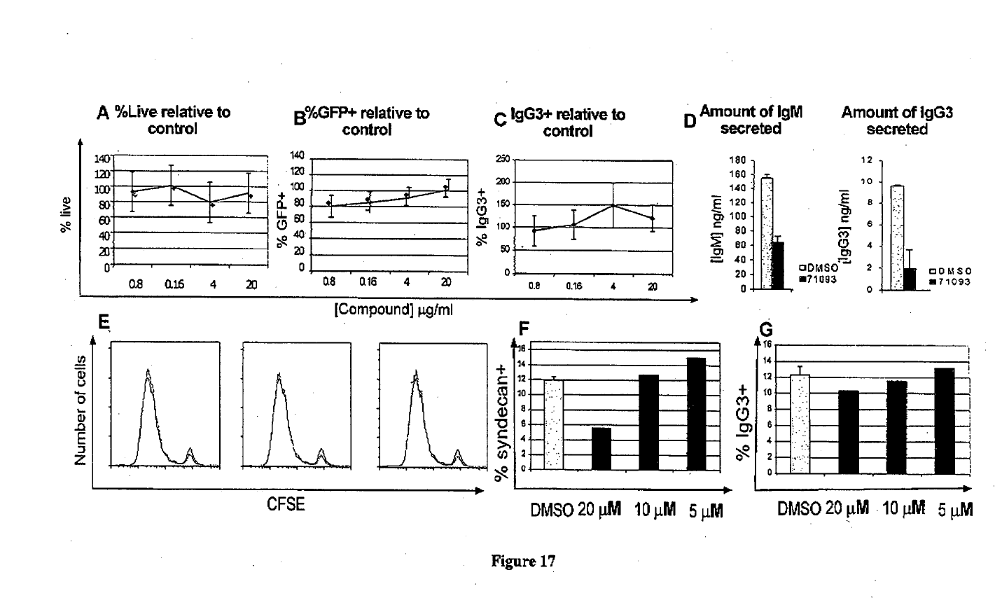

FIG. 17 shows two examples of compounds producing single effects. Compound WEHI-71093 (FIGS. 17A to 17D) had no effect on B cell proliferation (FIG. 17A), survival (FIG. 17A), switching (FIG. 17C), or differentiation into ASC (FIG. 17B). The sole effect was on the secretion rate of ASC already formed, as shown in FIG. 17D.

Compound WEHI-10601 (FIGS. 17E to 17G) had no effect on proliferation parameters, (FIG. 17E), but reduced the probability of becoming an antibody secreting cell, measured here by the expression of the ASC marker syndecan-1 (FIG. 17F).

Combining Actions of Independent Drugs

Knowing the quantitative values of independent parameters allows the cell population process and system to be used to evaluate the net effect of combining drugs on antibody output, thus identifying appropriate synergies and therapies prior to in vivo evaluation providing useful pre-screening.

Appendix

A Matlab implementation of the cell population data system and process is described below. For simplicity of description, the described implementation deals with cell division and death, but not differentiation. However, it will become apparent to those skilled in the art how to extend the described implementation to include all differentiation.

Given an initial number of undivided cells N₀, the cell population data generation system determines how many cells there in each division state at subsequent times. It is assumed that the times to divide and times to die of individual cells in a cell population are not fixed, but are instead each drawn from a corresponding probability distribution (probability density function) when the cells are created. The distribution parameters (including means μ and standard deviations σ) and even the type of distribution can differ for division and death, and also for undivided and blast cells. The (probability density function determining the) probability of dividing (in the absence of death) at time t is written as PdfDivᵢ (t), while the probability of dying (in the absence of division) is written as PdfDeathᵢ (t), where i=0, 1, 2, . . . is the division number.

The available time is divided into N suitably short intervals (typically about 1 hour or less). To determine how many live and dead cells there are at times t₀, t₁, . . . t_{N}, the cell population data generation process begins by determining the number of cells in each division that divide or die during each time interval. The proportion of cells that would divide in the j^{th} interval Δtⱼ from tⱼ₋₁ to tⱼ, in the absence of any death, is given by:

PDiv(Δt′ⱼ)= P̅d̅f̅D̅i̅v̅(̅Δ̅t̅ⱼ̅)̅·Δt=CdfDiv(tⱼ)−CdfDiv(tⱼ₋₁)

where the bar indicates an average over that time interval, and CdfDiv (t) is the cumulative probability density for division at time t generated from the time to divide probability distribution (probability density function). A similar expression holds for PDeath (Δtᵢ), the fraction of cells that would die in interval Δtᵢ in the absence of any division.

When division and death are competing to deplete the original population, several outcomes are possible. In a given time interval, cells can die but not divide, divide but not die, attempt to both die and divide, or do neither. For cells that would both divide and die in an interval, a fraction f is assigned to the divided cell cohort, and 1−f to the dead cell cohort.

Then in general the number of cells dividing in the time interval tᵢ is given by:

$$NumDiv [ j ] = {N}_{0} \cdot PDiv [ j ] \cdot ( 1 - {\sum }_{k = 1}^{j - 1} PDeath [ k ] - ( 1 - f ) \cdot PDeath [ k ] )$$

A similar expression provides the number dying in the same interval. However, in the absence of specific knowledge of the value of the fraction f, it is assumed that death dominates, i.e., that cells whose fated division and death times occur in the same interval ‘choose’ to die. Then f=0 and

$$NumDiv [ j ] = {N}_{0} \cdot PDiv [ j ] \times ( 1 - {\sum }_{k = 1}^{j} PDeath [ k ] )$$

$$and$$

$$NumDie [ j ] = {N}_{0} \cdot PDeath [ j ] \times ( 1 - {\sum }_{k = 1}^{j - 1} PDiv [ k ] )$$

Normally, the fate of a cell is determined by which of division and death occurs earlier. However, the process can take into account that a proportion of cells that reach the time to divide before they reach the time to die, do not in fact divide, instead remaining in the current division until they die. This proportion is represented by a progressor fraction pFᵢ (also written as P_{div}_{ᵢ} above), being the fraction of cells in division i that would divide. As indicated by the subscript, the progressor fraction can be different for cells in different divisions.

The cell population data generation process also takes into account that a proportion of the original undivided cells (i.e., in the zeroth division) will die as a result of the cell preparation method, referred to as mechanical death. Using all of the above, the number of undivided cells in division 0 that die and divide in each time interval tⱼ is given by:

$${NumDiv}_{0} [ j ] = SCN \cdot {pF}_{0} \cdot \overline{{PdfDiv}_{0} [ j ]} \cdot Δ t \times ( 1 - MechFrac \cdot CumPdfMech [ j ] - ( 1 - MechFrac ) \cdot {CumPdfDeath}_{0} [ j ] )$$

$$and$$

$${NumDie}_{0} [ j ] = SCN \cdot Δ t \times ( ( 1 - MechFrac ) \cdot \overline{{PdfDeath}_{0} [ j ]} + MechFrac \cdot \overline{{PdfMech}_{0} [ j ]} ) \times ( 1 - p {F}_{0} \cdot {CumPdfDiv}_{0} [ j - 1 ] )$$

In the above, PdfMech is the probability density for mechanical death, CumPdfMech is the cumulative probability density for mechanical death, MechFrac is the fraction of undivided cells subject to mechanical death, CumPdfDeath is the cumulative probability density for non-mechanical death (i.e., normal or natural cell death), CumPdfDiv is the cumulative probability density for division, and SCN is the starting cell number, N₀.

For cells that have already divided at least once, cells enter subsequent divisions at unsynchronised times. At each time interval in each division, a cohort of cells is created, with starting cell number twice the number of cells that left the previous division class through division in the previous time interval. As before, cells in each cohort randomly draw their division and death times from distributions, and the same formulae are used to determine the numbers of cells dividing and dying. The total numbers of cells that die or divide at each time for subsequent divisions is thus the sum of the values for each cohort at that time.

To determine the number of cells in division k dividing in each time interval, a temporary matrix is generated, as follows:

$${tmpdiv}_{k} [ i , j ] = \{ \begin{matrix}\begin{matrix}2 \cdot {NumDiv}_{k - 1} [ i ] \cdot p {F}_{k} \cdot \overline{{PdfDiv}_{k} [ j - i ]} \cdot Δ t \times \\ ( 1 - {CumPdfDeath}_{k} [ j - i ] )\end{matrix} & j > i \\ 0 & j \leq i\end{matrix}$$

where NumDivₖ₋₁[i] is the number of cells in division k−1 that divided in time interval i.

Then the number of cells dividing at each time is given by

$${NumDiv}_{k} [ j ] = {\sum }_{i} {tmpdiv}_{k} [ i , j ]$$

Similarly for the number dying, the matrix

$${tmpdth}_{k} [ i , j ] = \{ \begin{matrix}\begin{matrix}2 \cdot {NumDiv}_{k - 1} [ i ] \overline{{PdfDeath}_{k} [ j - i ]} \cdot Δ t \times \\ ( ( 1 - p {F}_{k} ) + p {F}_{k} \cdot ( 1 - {CumPdfDiv}_{k} [ j - i - 1 ] ) )\end{matrix} & j > i \\ 0 & j \leq i\end{matrix}$$

is summed to produce NumDieₖ[j].

Determining the number of live and dead cells in each division at each time then becomes a matter of accounting. The number of live cells is the difference between the running totals of those that enter a division and those that leave it, either through death or division.

First, an [(M+1)×(N+1)] matrix is generated, representing the number of live cells at each time, in each state of division.

$$\begin{matrix} & Time \\ Divisions & \begin{matrix} & 0 & 1 & 2 & … & … & N \\ 0 & & & & & & \\ 1 & & & & & & \\ ⋮ & & & & & & \\ ⋮ & & & & & & \\ M & & & & & & \end{matrix}\end{matrix}$$

At time 0 there are only undivided cells, so for the first column

$$LiveMatrix [ i , 0 ] = \{ \begin{matrix}SCN & i = 0 \\ 0 & i > 0\end{matrix}$$

For subsequent times, the first row is generated as

LiveMatrix [0,j]=LiveMatrix [0,j−1]−NumDiv₀[j]−NumDie₀[j]

while the remaining elements in rows 1 to M are generated as

LiveMatrix [i,j]=LiveMatrix [i,j−1]+2·NumDivᵢ₋₁[j−1]−NumDieᵢ[j−1]−NumDivᵢ[j−1]

Next, the [(M+1)×(N+1)] matrix representing the number of dead cells in each division at each time is generated.

The number of dead cells is determined by adding the number that die at each time to a running total of dead cells for each relevant division state. The process also takes into account that dead cells are not visible indefinitely, but rather disintegrate after some time. A dead cell survival time is thus assigned, and dead cells older than this time are removed from the total number of dead cells in each division.

$$DeadMatrix [ i , j = 0 ] = 0$$

$$DeadMatrix [ i , 0 < j < {S}_{i} ] = {\sum }_{k = 0}^{k = j} {NumDie}_{i} [ k ]$$

$$DeadMatrix [ i , j \geq {S}_{i} ] = {\sum }_{k = {S}_{i}}^{k = j} {NumDie}_{i} [ k ]$$

$$where$$

$${S}_{0} = Undivided survival time / Δ t$$

$$and$$

$${S}_{i > 0} = Blast survival time / Δ t$$

If experimental cell number data is available, it can be compared with the numbers generated by the cell population data generation process. Alternatively, CFSE profiles can be predicted from the generated cell population data, and compared directly with CFSE data.

If the probability distribution for times to divide in generation i is φⁱ(t), the corresponding distribution of times to die is Φⁱ(t), and the progressor fraction is yᵢ, then the conditional probabilities that a cell in generation i will die or divide at a time t, after its entry into that division, are respectively given by:

$${q}_{die}^{i} ( t ) = {Φ}^{i} ( t ) ( 1 - {p}_{div}^{i} {\int }_{0}^{1} {ϕ}^{i} ( τ ) d τ ) , \\ {q}_{div}^{i} ( t ) = {p}_{div}^{i} ( t ) {ϕ}^{i} ( t ) ( 1 - {\int }_{0}^{1} {Φ}^{i} ( τ ) d τ ) .$$

The number of cells alive in each division as a function of time is then given by the following set of ordinary differential equations:

$${\dot{n}}^{i} ( t ) = 2 {\dot{n}}_{div}^{i - 1} ( t ) - {\dot{n}}_{div}^{i} ( t ) - {\dot{n}}_{die}^{i} ( t ) , \\ {\dot{n}}_{div}^{i} ( t ) = {n}^{i} ( 0 ) {q}_{div}^{i} ( t ) + 2 {\int }_{0}^{t} {\dot{n}}_{div}^{i - 1} ( τ ) {q}_{div}^{i} ( t - τ ) d τ , \\ {\dot{n}}_{die}^{i} ( t ) = {n}^{i} ( 0 ) {q}_{die}^{i} ( t ) + 2 {\int }_{0}^{t} {\dot{n}}_{div}^{i - 1} ( τ ) {q}_{die}^{i} ( t - τ ) d τ .$$

This set of equations is then solved using standard methods well known to those skilled in the art.

As a further illustration, further details of an embodiment of the cell population process that can simulate the differentiation process of isotype switching, and of commitment to antibody-secreting cells are described. As described above, this cell differentiation process gives rise to four types of cells. The cell population process keeps track of their division number, their isotype, and their antibody-secreting state with the variables i,j,k respectively. The probability distribution for the time to divide of a cell in division i, of isotype j, and in antibody-secreting state k, is φ^{i,j,k}(t). The distribution of the times to die is Φ^{i,j,k}(t), times to undergo isotype switching η^{i,j,k}(t), and commitment to antibody secreting cell ξ^{i,j,k}(t). The progressor fractions for division, isotype switching and commitment, of cells in the state i,j,k, are respectively γ_{die}^{i,j,k}, γ_{sw}^{i,j,k}, γ_{com}^{i,j,k}, and the probabilities that a cell dies, divides, isotope switches, or differentiates at a time t after its birth are given by:

$${q}_{die}^{i , j , k} ( t ) = {Φ}^{i , j , k} ( t ) ( 1 - {γ}_{div}^{i , j , k} {\int }_{0}^{1} {ϕ}^{i , j , k} ( τ ) d τ ) ( 1 - {γ}_{com}^{i , j , k} {\int }_{0}^{1} {ξ}^{i , j , k} ( τ ) d τ ) ( 1 - {γ}_{sw}^{i , j , k} {\int }_{0}^{1} {η}^{i , j , k} ( τ ) d τ ) , \\ {q}_{div}^{i , j , k} ( t ) = {γ}_{div}^{i , j , k} {ϕ}^{i , j , k} ( t ) ( 1 - {\int }_{0}^{1} {Φ}^{i , j , k} ( τ ) d τ ) ( 1 - {γ}_{com}^{i , j , k} {\int }_{0}^{1} {ξ}^{i , j , k} ( τ ) d τ ) ( 1 - {γ}_{sw}^{i , j , k} {\int }_{0}^{1} {η}^{i , j , k} ( τ ) d τ ) , \\ {q}_{sw}^{i , j , k} ( t ) = {γ}_{sw}^{i , j , k} {η}^{i , j , k} ( t ) ( 1 - {γ}_{div}^{i , j , k} {\int }_{0}^{1} {ϕ}^{i , j , k} ( τ ) d τ ) ( 1 - {\int }_{0}^{t} {Φ}^{i , j , k} ( τ ) d τ ) ( 1 - {γ}_{com}^{i , j , k} {\int }_{0}^{1} {ξ}^{i , j , k} ( τ ) d τ ) , \\ {q}_{com}^{i , j , k} ( t ) = {γ}_{com}^{i , j , k} {ξ}^{i , j , k} ( t ) ( 1 - {γ}_{div}^{i , j , k} {\int }_{0}^{1} {ϕ}^{i , j , k} ( τ ) d τ ) ( 1 - {\int }_{0}^{t} {Φ}^{i , j , k} ( τ ) d τ ) ( 1 - {γ}_{sw}^{i , j , k} {\int }_{0}^{1} {η}^{i , j , k} ( τ ) d τ ) ,$$

From these equations, a set of ordinary differential equations for the number of live cells, of each of the cell types i,j,k, as a function of time is as follows:

$${\dot{n}}^{i , j , k} ( t ) = 2 {\dot{n}}_{div}^{i - 1 , j , k} ( t ) + {\dot{n}}_{com}^{i , j , k - 1} ( t ) + {\dot{n}}_{sw}^{i , j - 1 , k} ( t ) - {\dot{n}}_{div}^{i , j , k} ( t ) - {\dot{n}}_{die}^{i , j , k} ( t ) - {\dot{n}}_{com}^{i , j , k} ( t ) - {\dot{n}}_{sw}^{i , j , k} ( t ) , \\ {\dot{n}}_{div}^{i , j , k} ( t ) = {n}^{i , j , k} ( 0 ) {q}_{div}^{i , j , k} ( t ) + {\int }_{0}^{t} ( 2 {\dot{n}}_{div}^{i - 1 , j , k} ( τ ) + {\dot{n}}_{com}^{i , j , k - 1} ( τ ) ) {q}_{div}^{i , j , k} ( t - τ ) d τ + {\int }_{0}^{t} ( 2 {\dot{n}}_{div}^{i - 1 , j - 1 , k} ( τ ) + {\dot{n}}_{com}^{i , j - 1 , k - 1} ( τ ) ) \frac{{Q}_{sw}^{i , j - 1 , k} ( t - τ )}{1 - {Q}_{sw}^{i , j - 1 , k} ( t - τ )} {q}_{div}^{i , j - 1 , k} ( t - τ ) d τ , \\ {\dot{n}}_{die}^{i , j , k} ( t ) = {n}^{i , j , k} ( 0 ) {q}_{die}^{i , j , k} ( t ) + {\int }_{0}^{t} ( 2 {\dot{n}}_{div}^{i - 1 , j , k} ( τ ) + {\dot{n}}_{com}^{i , j , k - 1} ( τ ) ) {q}_{die}^{i , j , k} ( t - τ ) d τ + {\int }_{0}^{t} ( 2 {\dot{n}}_{div}^{i - 1 , j - 1 , k} ( τ ) + {\dot{n}}_{com}^{i , j - 1 , k - 1} ( τ ) ) \frac{{Q}_{sw}^{i , j - 1 , k} ( t - τ )}{1 - {Q}_{sw}^{i , j - 1 , k} ( t - τ )} {q}_{die}^{i , j - 1 , k} ( t - τ ) d τ , \\ {\dot{n}}_{sw}^{i , j , k} ( t ) = {n}^{i , j , k} ( 0 ) {q}_{sw}^{i , j , k} ( t ) + {\int }_{0}^{t} ( 2 {\dot{n}}_{div}^{i - 1 , j , k} ( τ ) + {\dot{n}}_{sw}^{i , j - 1 , k} ( τ ) + {\dot{n}}_{com}^{i , j , k - 1} ( τ ) ) {q}_{sw}^{i , j , k} ( t - τ ) d τ , \\ {\dot{n}}_{com}^{i , j , k} ( t ) = {n}^{i , j , k} ( 0 ) {q}_{com}^{i , j , k} ( t ) + {\int }_{0}^{t} ( 2 {\dot{n}}_{div}^{i - 1 , j , k} ( τ ) + {\dot{n}}_{com}^{i , j , k - 1} ( τ ) ) {q}_{com}^{i , j , k} ( t - τ ) d τ + {\int }_{0}^{t} ( 2 {\dot{n}}_{div}^{i - 1 , j - 1 , k} ( τ ) + {\dot{n}}_{com}^{i , j - 1 , k - 1} ( τ ) ) \frac{{Q}_{sw}^{i , j - 1 , k} ( t - τ )}{1 - {Q}_{sw}^{i , j - 1 , k} ( t - τ )} {q}_{com}^{t , j - 1 , k} ( t - τ ) d τ . \\ Where Q ( t ) = {\int }_{0}^{t} q ( τ ) d τ .$$

This set of equations is then solved using standard methods well known to those skilled in the art.

Many modifications will be apparent to those skilled in the art without departing from the scope of the present invention as hereinbefore described with reference to the accompanying drawings.

1. A cell population process executed by a computer system, the process including generating cell population data representing numbers of cells in a cell population from one or more probability distributions representing probabilities for cell division in the absence of cell death in successive generations of cells of said cell population, and one or more probability distributions representing probabilities for cell death in the absence of cell division in successive generations of cells of said cell population.

2. The process of claim 1, wherein said probability distributions represent probability densities as a function of time.

3. The process of claim 1, wherein at least one of said probability distributions changes with cell generation.

4. The process of claim 1, wherein said cell population data represents numbers of dividing cells in respective generations of cells, and numbers of dead cells in respective generations of cells.

5. The process of claim 4, wherein said cell population data also represents numbers of cells of different types in said cell population, the cell population data also being generated from one or more probability distributions representing probabilities for cell differentiation in the absence of cell division and cell death in successive generations of cells of said cell population.

6. The process of claim 1, wherein said cell population data is generated on the basis of a first probability distribution representing probabilities for cell division in an initial cell population, and at least one second probability distribution representing probabilities for cell division in subsequent generations of cells in said cell population.

7. The process of claim 1, wherein said cell population data is generated on the basis of a first probability distribution representing probabilities for cell death in an initial cell population, and at least one second probability distribution representing probabilities for cell death in subsequent generations of cells in said cell population.

8. The process of claim 1, wherein said cell population data is generated on the basis of a first probability distribution representing probabilities for cell differentiation in an initial cell population, and at least one second probability distribution representing probabilities for cell differentiation in subsequent generations of cells in said cell population.

9. The process of claim 1, including determining a number of cells in each generation that can divide, said number being a fixed proportion of the total number of cells in said generation.

10. The process of claim 1, including determining a number of cells in each generation that can divide, said number being a variable proportion of the total number of cells in said generation.

11. The process of claim 10, wherein the variable proportion varies with successive cell generations.

12. The process of claim 10, including determining the variable proportion on the basis of a truncated normal probability distribution.

13. The process of claim 1, including fitting said cell population data to corresponding measured cell population data to determine parameters of at least one of said probability distributions.

14. The process of claim 1, including fitting said cell population data to corresponding measured cell population data to determine number of cells in each generation that can divide.

15. The process of claim 1, including:
determining the effect of a first stimulus or genetic variation on at least one first parameter of at least one of said probability distributions;
wherein said step of generating cell population data includes generating, on the basis of the determined effect, cell population data representing numbers of cells in said cell population subject to said first stimulus or genetic variation.

16. The process of claim 15, including:
determining the effect of a second stimulus or genetic variation on at least one second parameter of at least one of said probability distributions; and
wherein said step of generating cell population data includes generating, on the basis of said determined effects on said at least one first parameter and said at least one second parameter, cell population data representing numbers of cells in said cell population subject to said first stimulus or genetic variation and said second stimulus or genetic variation to predict the combined effect of said first stimulus or genetic variation and said second stimulus or genetic variation.

17. The process of claim 15, wherein said first stimulus includes a drug.

18. The process of claim 15, wherein said first genetic variation includes a genetic mutation or polymorphism.

19. A process as claimed in claim 1, wherein one or more of said probability distributions is a skew distribution.

20. A process as claimed in claim 1, wherein one or more of said probability distributions is a gamma or Weibull distribution.

21. A process as claimed in claim 1, wherein one or more of said probability distributions is a lognormal probability distribution.

22. A system having components for executing the steps of claim 1.

23. A computer-readable storage medium having stored thereon program instructions for executing the steps of claim 1.

24. A cell population system, including means for generating cell population data representing numbers of cells in a cell population from one or more probability distributions representing probabilities for cell division in the absence of cell death in successive generations of cells of said cell population, and one or more probability distributions representing probabilities for cell death in the absence of cell division in successive generations of cells of said cell population.

25. The system of claim 24, wherein said cell population data also represents numbers of cells of different types in said cell population, the system being configured to generate said cell population data from one or more probability distributions representing probabilities for cell differentiation in the absence of cell division and cell death in successive generations of cells of said cell population.
